(19) United States
(12) Patent Application Publication
(10) Pub. No.: US 2013/0019443 A1
(43) Pub. Date: Jan. 24, 2013

(54) Recessed or Self-Rimming Sink Support Tool

(71) Applicant: Clinton Gomes, Pukalani, HI (US)

(72) Inventor: Clinton Gomes, Pukalani, HI (US)

(21) Appl. No.: 13/455,193

(22) Filed: Apr. 25, 2012

Related U.S. Application Data
(60) Provisional application No. 61/509,335, filed on Jul. 19, 2011.

(51) Int. Cl. B25B 27/00

(52) U.S. Cl. 29/270

(57) ABSTRACT

A drop-in or recessed sink installation tool is disclosed, wherein a plurality of supports is provided to allow a user to position and control a sink during the installation process using a mechanism that utilizes the structure of the sink for securement. The tool comprises a lower support platform, an upper support bridge and a clamping bolt spanning a gap therebetween. The lower support platform is adapted to articulate and enter through the base of the sink basin and rotate to support the sink's weight therebelow, while the upper support bridge spans across a countertop cut-out or the upper rim of the sink to clamp sink between the bridge and lower platform. The clamping bolt compresses the two elements together, whereafter the sink statically positioned or controlled from an overhead position. The tool can then be disengaged from above the installed sink and condensed into a stowed position thereafter.

### CROSS REFERENCE TO RELATED APPLICATION

This application claims the benefit of U.S. Provisional Application No. 61/509,335 filed on Jul. 19, 2011, entitled “Sink Helper.”

### BACKGROUND OF THE INVENTION

### Field of the Invention

The present invention relates to sink tools and assembly supports that assist in the installation thereof. More specifically, the present invention pertains to a recessed or self-rimming drop-in sink installation tool that facilitates ease of installation without external supports and allows improved handling for the sink during installation.

Self-rimming drop-in sink basins are structures that are positioned on a countertop and supported by a perimeter ridge that supports the sink once placed through a hole in the countertop. The perimeter is generally caulked below the ridge or fastened therethrough to create a secure join, whereafter installation plumbing can be connected and the sink can begin to operate. The installation process generally is as follows: tracing an outline template of the basin on an existing countertop, cutting along the trace line to create a cutout for the basin to be positioned into, caulking the perimeter of the cutout and manually lifting and placing the sink into the opening. The final step of the process can be difficult for a single user or when placing larger sinks or those of ornate structure into the cutout. These sinks are generally difficult to handle, as they provide little to know placement for an installer's hands to grasp the device while being positioned into the cutout. Further, the material of a sink basin is generally very dense, which makes such structure very heavy. Combining their weight with their bulk and overall dimensions, sink basins can be a very difficult structure to handle by hand and without external supports. Dropping or mishandling of such structures can also be disastrous, as ceramic sinks can be very brittle and easily break if mishandled or dropped, resulting in excess expense, time and aggravation for an installer or homeowner.

Recessed or undermount sinks are mounted from below the countertop, wherein a cutout for the sink is not overlapped with a sink rim, but rather the upper edge of the sink abuts against the underside of the countertop. Caulking and fasteners are utilized to join the sink to the countertop underside surface, whereafter the sink is statically positioned and ready for use. Supporting the sink prior to its joining with the countertop underside surface can be an exhaustive task and one that requires assistance or third party support articles. The sink must be raised and statically positioned to align fastener locations and allow the caulk to dry at the joined area. Supporting this load while attempting to manipulate fastener tools or holding this position over a longer period of time is unnecessarily taxing, and the use of external supports is not always ideal. Supports must be specifically sized and positioned in order to properly apply pressure on the join and support the sink in the proper location. Dropping the sink during the process can lead to fracturing or damage to the sink structure, adding time, cost and hassle to the process.

The present invention pertains to a sink installation tool that is adapted to address the common installation and handling problems associated with both recessed and rimmed sinks. For rimmed sinks, the tool is a device that clamps against the upper and lower regions of the sink and provides a bridge for which to allow improved purchase and control over the structure as it is handled and positioned into a countertop cutout. A first and second support are compressed on the top and bottom of the sink basin, comprising a lower support platform positioned below the sink, an upper support bridge spanning the upper rim of the sink basin, and a clamping bolt that feeds through the sink drain hole and clamps the two elements together. Once in connection with the sink and secured thereto, the user may grasp the upper support bridge or utilize a winch to carefully install the sink into the countertop with less physical exertion and improved grip on the device. For recessed sinks, the upper bridge spans the width of the countertop cutout and provides a secure location for which to draw the sink towards the countertop underside surface utilizing the clamping bolt and lower platform support positioned underneath the sink. The clamping bolt is tightened to compress the sink against the counter top, facilitating a hands-free installation tool that allows a user to insert fasteners without simultaneously supporting the sink. The compression also facilitates compression of the caulk and a watertight connection therebetween.

After installation, the present device is adapted to fold into a parallel configuration for improved storage and for feeding the device through a sink drain hole after securement to the target countertop. It can be decoupled and removed from the drain without climbing under the sink after installation and without completely disassembling the clamping bolt from the upper support bridge and lower support platform. The tool can be fed through the sink hole and removed therefrom from overhead, reducing strain and time wasted for a user. The stowed position also allows for improved storage after use.

### DESCRIPTION OF THE PRIOR ART

Devices have been disclosed in the prior art that describe sink tools; however most describe garbage disposal installation tools with varying structures and means therefor. Devices described below been patented or published relating to the present sink installation tool. These devices lack elements that describe the present invention purpose and intent, and further fail to achieve the same level of control and improved purchase over a sink basin during installation. The following is a brief summary of each prior art device considered relevant to the present invention. Most relate to garbage disposal and sink lifting means that support from below an installation and can be jacked or raised into position. Others relate to recessed sink basin tools with differing elements with regard to the present invention.

Specifically, U.S. Pat. No. 7,401,392 to Ramsey discloses a garbage disposal installation tool that comprises a hydraulic jack, a base with attached wheel assemblies and an extensible column that provides support for a garbage disposal unit being lifted into position and installed under a sink. The device is adapted to provide support for the large mass of the disposal, while also providing a means to lift the assembly into a position wherein it can be easily installed without manually holding the disposal in position. While providing a novel means to position a garbage disposal, the Ramsey device fails to provide a means to support a drop-in or recessed sink from overhead, which is a preferred method of installation thereof. The present invention relates to a simple, handheld support tool that utilizes the drain opening and upper basin rim or cutout rim to carefully support and install either a drop-in or recessed sink.

Similar to the Ramsey device is U.S. Pat. No. 6,142,460 to Irwin, which discloses a support device for mounting and dismounting a garbage disposal unit from below a sink. The device comprises a base, a garbage disposal support tray and an extensible member. The tray position is controlled by the extensible member and pinned into a static position during use. The tray itself provides inwardly facing pins to secured a garbage disposal unit thereon and prevent dislodgement during installation or removal. The Irwin device falls into the same category as the Ramsey device in its failing to disclose similar elements that comprise the present invention.

U.S. Patent Application Publication Number 2010/0230563 to Flynn discloses an adjustable support device mounted beneath a countertop and adapted to support a rimless and rimmed countertop fixture without the use of counter attaching hardware. The device comprises mounting brackets having attached moveable carriages and length adjustable hanger beams attached to opposing movable carriages. A sanitary fixture is supported by the assembly such that the fixture does not have to be attached to the countertop and is supported therebelow. The Flynn device is a support assembly for permanent fixturing of a countertop assembly and provides an alternate means to position a sink or similar fixture in connection with a countertop cutout. The device does not disclose a means of temporary support for a rimmed or recessed sink fixture as it is lowered or raised towards a countertop cutout location. The present device is adapted to aid installers during this process, whereafter it is removed from the sink and stowed.

U.S. Patent Application Publication Number 2003/0014812 to Feilmoser discloses a device utilized for undercounter installation of a lavatory sink, comprising a crossbrace piece having a coupling member and a hanger arm having a securement member. The device forms a cruciform structure so as to facilitate the positioning of a lavatory sink by a single individual. While the Feilmoser device discloses a device of similar intent, the elements of the device differ from the present invention. Most notably, the present invention provides an upper and lower support, wherein the upper support bridge allows a sink fixture having either a rimmed or recessed peripheral edge to be positioned into a countertop cutout, wherein the bridge extends beyond the edge of the sink to support the structure on the countertop if the sink rim is recessed. The device securely engages to the sink being installed, and can easily be disengaged therefrom and removed without requiring the user to disassemble the device or bend over to decouple its lower support platform.

It is therefore submitted that the present invention is substantially divergent in design elements from the prior art, and consequently it is clear that there is a need in the art for an improvement to existing sink installation devices. In this regard the instant invention substantially fulfills these needs.

### SUMMARY OF THE INVENTION

In view of the foregoing disadvantages inherent in the known types of sink installation and support tools now present in the prior art, the present invention provides a new sink installation tool wherein the same can be utilized for providing convenience for the user when installing either drop-in, self-rimming sinks or recessed, undermount sinks.

It is therefore an object of the present invention to provide a new and improved sink installation and support device that has all of the advantages of the prior art and none of the disadvantages.

It is another object of the present invention to provide a sink installation tool that is capable of supporting a sink and assisting installation of both self-rimming and recessed sinks using the same tool.

Another object of the present invention is to provide a sink installation tool that supports both sink types and can be disengaged from the installed sink without disassembly of the tool itself. The tool lower platform is rotated into an aligned configuration and fed through the sink basin hole with ease, facilitating improved removal with little manipulation of the tool.

Yet another object of the present invention is to provide a sink installation tool than can be condensed into a stowed state for improved storage and transport thereof.

A final object of the present invention is to provide a simple, inexpensive and easily manufactured tool for facilitating sink installation by either a professional installer or individual homeowner.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of the present sink installation tool in a working position.

FIG. 2 shows an underside perspective view of the present sink installation tool in a working position.

FIG. 3 shows a perspective view of the present sink installation tool in a condensed, stowed position.

FIG. 4 shows a view of the present sink installation tool being utilized to support a recessed sink fixture during installation.

### DETAILED DESCRIPTION OF THE INVENTION

Reference is made herein to the attached drawings. Like reference numerals are used throughout the drawings to depict like or similar elements of the sink installation tool. For the purposes of presenting a brief and clear description of the present invention, the preferred embodiment will be discussed as used for installing either recessed or drop-in sink fixtures. The figures are intended for representative purposes only and should not be considered to be limiting in any respect.

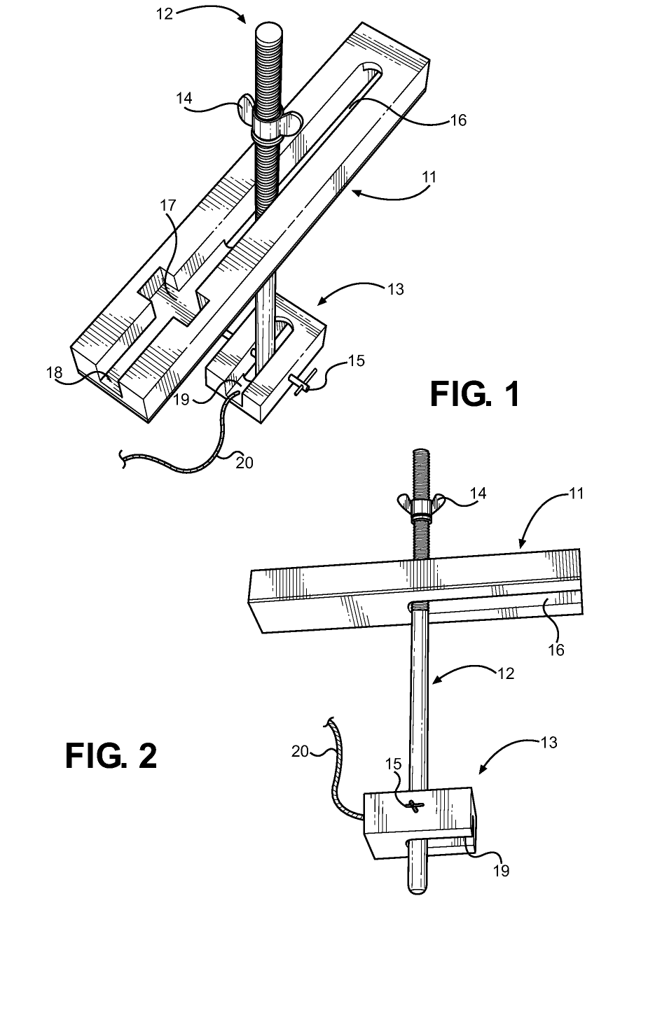

Referring now to FIG. 1, there is shown an overhead view of the sink installation tool of the present invention, wherein the tool is configured in a working configuration. The tool comprises an upper support bridge 11, a lower support platform 13 and a threaded clamping bolt 12 attaching therebetween. The upper support bridge 11 comprises an elongated member having a central channel 16 for which the clamping bolt 12 to freely slide along the bridge length. The channel 16 extends vertically through the bridge 11, allowing the bolt through-access. The lower support platform 13 is rotatably connected to the lower portion of the clamping bolt 14 extending below the upper support bridge 11. Along a length of the clamping bolt 12 and above the bridge 11 is a clamping nut 14 and washer, which act to apply pressure against the upper surface of the bridge 11 and compress the bridge 11 towards the lower support platform 13.

While in a working position, as shown in FIG. 1, the lower support platform 13 is adapted to support the lower portion of a sink basin, which rests thereagainst. The clamping bolt 12 connects the lower support platform to the upper support bridge, which is adapted to span a distance across a countertop cutout and be compressed thereagainst. In this way, a recessed sink installation is drawn closer to the underside of the countertop as the clamping nut 14 advances the bolt 12 through the bridge 11 and draws the lower support platform upwards toward the upper support bridge until the sink is compressed against the countertop underside surface. A line of caulking can be compressed at the joining area between the sink rim and the countertop, while the static position of the sink created by the compressive forces exerted thereon allow a user to independently locate and install fasteners required to permanently secure the sink to the countertop underside surface, all while the disclosed tool supports the sink in position.

The elements of the device are adapted to be stowed when not in use and facilitate ease of removal after sink installation. After a sink has been fastened and caulked into its final destination under a sink, the clamping nut 14 can be withdrawn to remove tension on the clamping bolt 12 and the pressure exerted on the sink and countertop by the assembly. The bridge channel 16 of which the bolt 12 is positioned does not allow the bolt to be removed without completely disconnecting the nut 14 therefrom. This allows the lower platform 13 to hang freely and prevents fall-through. The lower platform 13 can then be rotated in alignment with the bolt 12 via rotation about a pin 15 that connects the two. A channel 19 within the platform allows the platform 13 to align with the bolt 12 and to condense its overall width. This permits the rotated platform to be pulled upwards and through the drain hole of the sink for ease of removal. The platform 13 can be rotated by a user standing above the installed sink via a control string 20 that is fed upwards through the drain hole, facilitating rotation of the platform without requiring the user to bend over or reach under the sink. During the removal process, the nut 14 does not need to be completely removed from the bolt 12 and the platform 13 and bridge 11 can remain loosely coupled. This loose coupling allows the upper bridge 11 to freely rotate about the bolt and the bolt to freely slide along the channel 16 length when a sink installation and countertop are not being compressed within the tool assembly.

After the nut 14 has been loosened and the lower platform has been fed through the sink drain hole, the device is free of the sink. A groove 18 along a proximal end of the bridge 11, along with a clamping nut cut-out 17, allows the bolt to rotate into alignment with the bridge and stow into the body region thereof after the device has been utilized. This provides a condensed, stowed state for which to transport or to store the device for later use.

Referring now to FIG. 2, there is shown an underside perspective view of the present invention in a working position. As shown, the bridge channel 16 is extends along the bridge length to a closed distal end. The channel 16 allows the bolt 12 to translate along the bridge length, but prevents the bolt from coming separated from one side without complete disassembly of the nut 14 from the bolt upper region. During operation, the nut 14 and associated washer are compressed against the upper surface of the bridge 11, allowing the lower platform 13 to be drawn towards a sink installation between the bridge and platform, wherein the two elements either compress a rimmed sink or compress a recessed sink against the underside of a countertop. The washer broadens the surface area for which the compressive load is spread on the bridge 11, while the nut 14 may be provided in a winged configuration to facilitate tightening by hand. When a self-rimming sink is being compressed, the platform 13 and bridge 11 tightly connect on an upper and lower edge of the sink, allowing a user to gain improved purchase over the sink being lowered into a countertop cutout and facilitating improved control thereover. The perimeter rim of the sink then sits against the cutout periphery, wherein caulking is provided to create a seal while further fastening may be applied thereto to create a secured join. In the same procedure as with the installation of a recessed sink, after installation of the self-rimming sink, the clamping nut of the device is loosened 14 and the platform 13 is rotated about its pin joint 14 by the control string 20, allowing the assembly to be removed from above the sink and through the drain hole thereof.

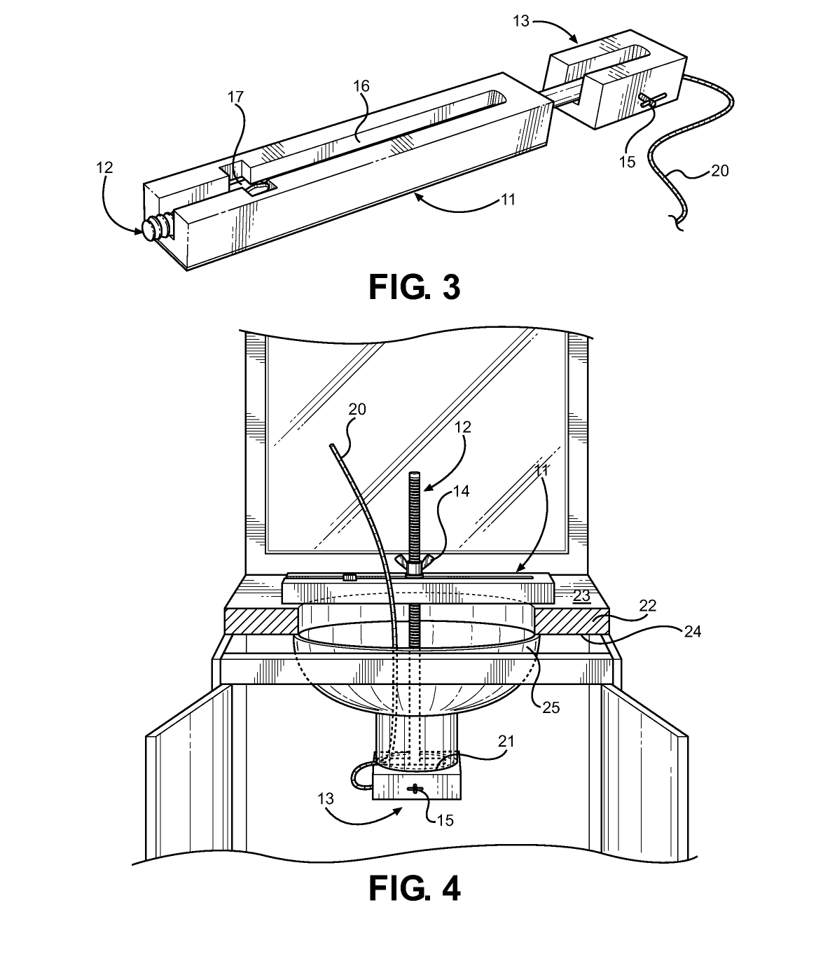

Referring now to FIG. 3, there is shown a perspective view of the present sink installation tool in a condensed, stowed state. As shown, the elements of the device are alignable so as to facilitate improved storage and transportation thereof. The clamping bolt 12, once disengaged from a compressed sink installation, is free to rotate within the channel 16 of the upper bridge body 11 so as to align the elements of the tool. The nut 14 is positioned within a cutout 17 along the channel that accepts the increased diameter thereof. The channel 16 within the bridge is designed to be of sufficient width to allow the bolt 12 to easily slide therein, while being sized less than the diameter of the nut 14 and associated washer. This allows the nut/washer to exert a force on the bridge 11, apply tension to the bolt 12 and compress the lower support platform 13 against the underside of a sink assembly and prevent pull-through of the nut during operation. In a similar fashion, the lower support platform 13 is rotatable about its pin connection 15, wherein its channel allows the bolt 12 to be aligned therewith for easily removal through a sink drain hole and for aligned positioning thereof for storage. In this configuration, the control string 20 can be wrapped around the assembly to keep the elements in position for extended stowage or transport.

Referring now to FIG. 4, there is shown a view of the present sink installation tool in a working position, being utilized to install a recessed sink 25 beneath a countertop 22. As shown, the lower support platform 13 supports the drain hole rim 21 of the sink, while the clamping bolt 12 runs through the drain hole and connects to the upper support bridge 11 spanning the width of the countertop sink cutout. The clamping nut 14 is advanced along the bolt 12 until tension develops in the bolt as the sink is raised towards the underside surface 24 of the countertop 24. The bridge 11 is supported on the upper surface 23 thereof, and the nut compresses the sink 25 against the countertop 24 and between the platform/bridge of the device. This allows the sink to be supported without direct user vigilance. A line of caulking along the upper rim of the sink 25 can be compressed, whereafter any securing fasteners or bracketry that hold the sink in position can be secured by the user, whose hands are now free to operate without supporting the sink 25. Once the sink is secured, the nut 14 can be withdrawn, releasing the compression of the sink between the bridge 11 and the platform 13. The control string 20, which is fed through the drain hole of the sink, is then pulled to rotate the lower support platform 13 into an aligned position with the bolt 12, whereafter the platform and bolt can be drawn through the drain hole to remove the entire assembly. This task eliminates the need to completely disassemble the elements or to reach under the sink after installation has been completed.

Installing sinks can be a difficult and laborious process. Workers are often required to lift and support sinks in their seated position beneath a countertop while simultaneously applying securing members thereto (securing nuts and bolts). This process requires considerable strength and agility, and workers' arms may become very tired over a short time period. If workers' arms become fatigued, or if workers cannot maintain secure grasps on the sinks, the sinks may fall and break. Replacing a broken sink can be very expensive, and may cause a significant loss of work time. The present invention provides means to support a recessed sink installation and also provides improved purchase on a self-rimming sink during drop-in. Utilization of the present device significantly reduces the physical exertion of installers, along with the time and skill required. The device further improves one's ability to independently install a sink without extra workers, for both professional installers and individual homeowners.

The base of the upper platform may be coated in soft or compressible padding material to prevent scoring or scratching of the countertop upper surface. Further, the lower platform may be separable from its connection with the clamping bolt, wherein a cotter pin is provided that allows the pin to be removable. This facilitates the device use with sinks having smaller drain holes, wherein the assembly can be disassembled via the clamping nut and the cotter pin if necessary to facilitate installation of the sink. A further embodiment contemplates an upper support channel having a means to rotatably support the clamping bolt and facilitate drawing saw lower platform thereto without an independent clamping nut. The top of said clamping bolt would employ a hand cranking element to rotate said bolt, while a rotatable set of threads in said upper support channel would apply loads to said bridge and allow rotation into an aligned state. This embodiment is considered more complex and a less desirable construction, but is a contemplated construction that facilitates the same goals as the preferred embodiment.

In use, with a sink properly positioned and supported by the present tool, workers can use both hands to screw in the appropriate fastening mechanisms, such as nuts and bolts. After use, users may pull a platform control string attached to the lower platform to lift device through the drain hole and remove it from the sink. The platforms can then be folded flat against the rod, and the unit may be stored until needed for later use.

It is submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sink installation tool, comprising:
an upper support bridge, a lower support platform and a clamping bolt therebetween;
said clamping bolt adapted to draw said upper support bridge and said lower support platform together;
said lower support bridge adapted to support a sink thereon.

2. The device of claim 1, wherein said lower support platform is rotatably connected to a lower region of said clamping bolt.

3. The device of claim 2, wherein said rotatable connection is a removable pin joint that allows complete separation of said bolt and said lower support platform.

4. The device of claim 1, wherein said upper support bridge further comprises a lengthwise channel adapted to allow free translation of said clamping bolt and free rotation thereof in alignment with said bridge length.

5. The device of claim 4, wherein said bridge channel further comprises closed ends to prevent said clamping bolt from being separable from said bridge without removal of an upper clamping nut fastened to said bolt.

6. The device of claim 1, further comprising a clamping nut along said bolt and above said bridge, adapted to apply pressure against said bridge upper surface and draw said lower support platform towards said bridge.

7. The device of claim 1, wherein said tool has a stowed configuration, wherein said clamping bolt is rotatable in alignment with a channel along said bridge length, and said lower support platform is rotatable along said clamping bolt length, creating an aligned state.

8. The device of claim 7, wherein said bridge channel provides a location for a clamping nut along said clamping bolt when aligned with said bridge length.

9. The device of claim 1, wherein said lower support platform further comprises a control string that allows a user to rotate said platform in alignment with said clamping bolt by pulling on said string.

10. The device of claim 1, wherein said upper support bridge further comprises a lower surface having a compressible padding material to prevent marring or damage to a countertop surface.

11. The device of claim 1, wherein said upper support bridge is adapted to rest against a countertop upper surface and support a recessed sink in position beneath a countertop via said clamping bolt being positioned through said sink drain hole and drawing said lower support platform toward said countertop.

12. The device of claim 1, wherein said upper support bridge is adapted to rest against a self-rimming sink upper region, while said clamping bolt is positioned through said sink drain hole and compressing said lower support platform against said sink lower region for utilizing the attached tool for improved purchase during installation.
